(19) United States
(12) Patent Application Publication
(10) Pub. No.: US 2025/0361847 A1
(43) Pub. Date: Nov. 27, 2025

(54) METHODOLOGY FOR DESIGNING A TANDEM TOWER MACHINE FOR GENERATING ELECTRICITY

(71) Applicant: Gravitas E2P Inc., Rancho Santa Fe, CA (US)

(72) Inventor: Neil K. Nydegger, Rancho Santa Fe, CA (US)

(21) Appl. No.: 18/674,839

(22) Filed: May 25, 2024

(51) Int. Cl. F03B 13/06; F03G 3/00

(52) U.S. Cl. CPC F03B 13/06; F03G 3/096; F05B 2200/12; F05B 2210/11; F05B 2220/707; F05B 2260/506; F05B 2260/84

(57) ABSTRACT

A methodology for designing a machine to generate electricity using the forces of gravity and buoyancy is provided which generates an output sufficient to sustain the machine's operation and provide a remainder amount of electricity for commercial purposes. The machine has two independent electricity generating units. Output work, Uₒ, for each generating unit is based on the kinetic energy of a buoyant shuttle falling under the influence of gravity, and each unit's input requirement, Uᵢ is based on the work required to manipulate a volume of water during shuttle transit through water tanks of the machine. The methodology is based on a pre-selected output power Pₒ which is used to establish machine component configurations. The shuttle's kinetic energy is then compared to Uᵢ to evaluate the machine's operational efficiency.

### FIELD OF THE INVENTION

The present invention pertains to machines that generate electricity. More specifically, the present invention pertains to electricity generators that operate with motive forces from the earth's gravitational field, i.e. gravity and buoyancy. The present invention is primarily, but not exclusively, useful for designing and configuring electricity generating systems that incorporate twin electricity generators which operate in tandem using a common feedback power from the machine's output during a machine work cycle.

### BACKGROUND OF THE INVENTION

It is well known that for a mechanical machine to do work some parts of the machine must move. Furthermore, moving parts of a machine must somehow interact with other parts of the machine to do the work. All of this takes time. In each case, the ultimate objective has always been to design and configure a machine that is useful for a specific purpose.

The specific purpose of the present invention is to design a machine which will generate electricity. Like all machines, the machine of the present invention requires an input power for its operation. Also like other machines, the machine of the present invention must generate a useful output. In this case, of course, the useful output is electricity.

Unlike other machines, the only motive forces required for an operation of the present invention are provided by the earth's gravitational field. Specifically, the machine of the present invention uses the force of gravity to generate its electricity output. The machine then uses the force of buoyancy to reset the machine for its next machine duty cycle. Thus, in its closed loop operation, a machine of the present invention is non-polluting, self-sustaining, and economically viable. Nota bene, the machine of the present invention is NOT (emphasis added) a perpetual motion machine.

The defining aspect of a machine for the present invention is in the transfer of power between internal components of the machine. Namely, these components are a hydro-electric component that generates the machine's electricity output, and a hydro-mechanical component that uses a portion of the feedback from the machine's electricity output to run the hydro-electric component of the machine. In this combination, the machine must be designed and configured to provide an electricity output that is greater than the feedback from the output needed to run the machine.

It is an object of the present invention to provide a methodology for designing and configuring a machine for generating electricity which runs exclusively off the gravity and buoyancy forces provided by the earth's gravitational field. It is another object of the present invention to provide a machine for generating electricity which is environmentally safe, is self-sustaining, is cost effective and commercially viable.

### SUMMARY OF THE INVENTION

In accordance with the present invention, a machine for generating electricity includes a pair of water tower tanks. In combination, each water tower is vertically aligned with a linear generator to establish separate electricity generating units. The water towers of both electricity generating units are individually connected in fluid communication with a respective water chamber of a transfer tank. Thus, the two electricity generating units and the two water chambers of the transfer tank constitute a hydro-electric component of the machine which generates the machine's electricity output.

Connected with the hydro-electric component of the machine is a mechanical component that provides the power needed to run the hydro-electric component. The connection between the mechanical component and the hydro-electric component of the machine is bifurcated.

Specifically, a mechanical connection between machine components involves a piston that is positioned in a conduit between the two water chambers of the transfer tank. At this location, the piston is reciprocated back and forth between the two electricity generating units of the hydro-electric component. Consequently, during a machine work cycle, piston movements will alternately power both electricity generating units. Also, an electrical connection is used to feedback electricity from the machine's output to run the mechanical component.

Structurally, the mechanical component of the machine includes a cam drive which is operationally rotated around an eccentric axis of rotation. Also, the cam drive abuts a drive rod so that eccentric rotations of the cam drive cause the drive rod to move back and forth in a reciprocating movement on a linear path. Furthermore, the drive rod is connected to both a recoil spring and to the piston.

In detail, the cam drive of the mechanical component is designed so that the distance between its eccentric axis of rotation and its periphery will change as a rotation angle θ for the drive cam changes through a 360° rotation around the eccentric axis. An important aspect of the present invention is that this 360° rotation drives both electricity generating units of the machine during the same machine work cycle, albeit 180° out of phase with each other. Stated differently, as the drive cam rotation energizes one electricity generating unit, it resets the other electricity generating unit, and vice versa. In this context, an operation of the machine can be considered in terms of piston movements caused by a cam drive rotation.

For simplicity, first consider only one electricity generating unit and its engagement with the cam drive of the mechanical component. A change in the cam drive rotation angle θ from 0° to 180° is designed to increase the distance between the eccentric rotation axis of cam drive and the cam drive periphery by a distance “s”. This increase in “s” moves the drive rod to energize both the piston and the recoil spring. For one, a piston movement manipulates water levels in an electricity generating unit for its operation. For the other, the recoil spring is compressed to store energy having a value “sk”, where “k” is a spring constant.

On the other hand, as θ then changes from 180° to 360°, the distance between the eccentric axis and the periphery of the cam drive is decreased by the distance “s”. This decrease in “s” resets the cam drive and the drive rod for the next machine work cycle. Further, this decrease in “s” decompresses the recoil spring for use of its stored energy to operate the other tandem electricity generating unit. Importantly, in this reciprocation, the distance “s” is equal to both the distance that the piston is reciprocated, and the distance that the recoil spring is compressed.

From a work perspective, consider the piston is moved to the left through the distance “s” as the drive cam rotates through the θ arc from 0° to 180°. Although this is only the first half of a complete machine work cycle, piston movement during the first half work cycle does all of the total input work required to operate the machine. Specifically, the input work has two separately identifiable work units, i.e. Uᵢ₍ₜₒₜₐₗ₎=2Uᵢ. During this first half of a machine work cycle, one unit of input work is used, U_{i(mgH)} is used to raise the water level in the water tower of the left electricity generating unit. The second unit of input work Uᵢ₍ₛₖ₎ is stored by the recoil spring as it is compressed, wherein “s” is the compression distance and “k” is the spring constant. Also note, as the piston is moved to the left, the water level in the water tower of the right electricity generating unit is being lowered for a reset of that unit.

During the second half of a machine work cycle, as the piston is moved to the right while the drive cam rotates through the θ arc from 180° to 360°, the second unit of input work stored in the compressed recoil spring, Uᵢ₍ₛₖ₎, is released. Specifically, Uᵢ₍ₛₜₖ₎ is now used to raise the water level in the water tower of the right electricity generating unit. An important consequence here is that when considering a complete machine work cycle, θ arc from 0° to 360° the total output work, Uᵢ₍ₜₒₜₐₗ₎=2Uᵢ.

Unlike the total input work, i.e. Uᵢ₍ₜₒₜₐₗ₎=2Uᵢ, which is fixed for each machine work cycle, the total output work Uₒ₍ₜₒₜₐₗ₎ is cumulative during each machine work cycle. This happens because the design of a machine starts with the selection of a desired output power, Pₒ, e.g. Pₒ=100 kW, where a watt, W, is defined as work per second, i.e. W=Uₒ/sec. Consequently, time is an important consideration for the output work. However, as a design criterion, the value of Uₒ can be evaluated in accordance with the well-known work energy relationship: ∫Fds=½mₛvₑ². Stated differently in the context of the present invention, the work done by a force “F” through a distance “s” equals the shuttle's kinetic energy expended as the shuttle moves through the distance “s”. It is important to note that this relationship alone can be used to determine both physical and operational characteristics of the shuttle (weight and velocity) and of the linear generator (length) for the machine's operation.

From a dynamics perspective, based on the engagement velocity of the shuttle, vₑ. with the linear generator, and the length of the linear generator, Lₑ, the time duration of shuttle engagement with the linear generator can be determined as X seconds=Lₑ/vₑ. Thus, because the machine has two electricity generators with a same length Lₑ, Uₒ₍ₜₒₜₐₗ₎=2XUₒ. The result is:

$$U net = {U}_{o ( total )} - {U}_{i ( total )} = 2 {XU}_{o} - 2 {U}_{i}$$

The value of X in the above expression, however, must be considered in the context of a machine operation. For one, X must be less than the time required for a shuttle to transit from the linear generator, through the transfer tank, and into the tower tank of an electricity generating unit. Furthermore, X must be greater than the ratio Uᵢ/Uₒ where Uᵢ=m_{w}gH and Uₒ=Xmₛgh. In this comparison, mw is the water mass being moved the a head height H, and ms is the shuttle mass being moved along the length of the linear generator, i.e. Lₑ=Xh.

It is also important to note that, for an operation of the machine, rotations of the cam drive are powered by a closed-loop feedback arrangement wherein a portion of the machine's total output work, Uₒ₍ₜₒₜₐₗ₎ is feedback and is used as input work, Uᵢ, to run the machine. Accordingly, the machine can be engineered to be self-sustaining in accordance with feedback control theory.

### BRIEF DESCRIPTION OF THE DRAWINGS

The novel features of this invention, as well as the invention itself, both as to its structure and its operation, will be best understood from the accompanying drawings, taken in conjunction with the accompanying description in which similar reference characters refer to similar parts, and in which:

FIG. 1 is a perspective view of an electricity generating machine in accordance with the present invention;

FIG. 2 is a cross section view of the machine as seen along the line 2-2 in FIG. 1;

FIG. 3 is a plan view of the drive cam of the present invention;

FIG. 4 is a presentation of mechanical parts in the hydro-mechanical electricity generating unit of the machine which provide the input work needed to run the machine;

FIG. 5 includes free body diagrams showing the change in forces acting on the piston and the recoil spring that provide the input power during a machine work cycle;

FIG. 6 is a diagram showing time zone components of a machine work cycle;

FIG. 7 is a presentation of output power segments along a linear generator relating to the distances traveled by a shuttle while engaged with the linear generator during a machine work cycle; and

FIG. 8 is a protocol presentation of steps in a methodology for empirically designing a machine in accordance with the present invention.

### THEORETICAL OVERVIEW OF THE INVENTION

An appreciation of the definitions and mathematical expressions upon which the design of a machine are based is essential for an understanding its structure and its operation. Specifically, basic definitions for the terms WORK, POWER, and ENERGY are indispensable for this purpose. The definitions presented below are excerpted from the Dictionary of Science and Technology, Academic Press, 1992.

WORK, “U”, is defined as a force, “F”, times a distance, “s”. Work is mathematically expressed in units of ft-lbs; where U=∫ₛFds.

POWER, “P”, is defined as the time rate of doing work. It is mathematically expressed in units of work per unit time, ft-lbs/sec; P=U/sec.

ENERGY, “E”, is defined as the capacity to do work. “E” is simply expressed in units of ft-lbs.

Potential Energy, “PE” is the energy of position.

Kinetic Energy “KE” is the energy of motion.

It is noteworthy that in the above definitions, only Power “P” directly requires the consideration of time. Work “U” and Energy “E”, however, are influenced by time. In the work-energy relationship which is based on Newton's Second Law of motion, “F=ma”, the notion of time is introduced with the consideration of an object's acceleration “a”. Thus, In the context of the present invention, the shuttle mass, “mₛ” does work, “U”, with a force F=mₛg as it falls under the influence of gravity “g” while engaged with a linear generator.

As indicated above, work is mathematically expressed as U=∫ₛFds. Thus, because the shuttle mass mₛ is related to the shuttle weight by the expression mₛ=wₛ/g, the force F can be expressed as F=(wₛ/g)a. Furthermore, acceleration “a” is mathematically expressed as a change in velocity per unit time, a=dv/dt. And, velocity “v” is expressed as a change in distance per unit time, v=ds/dt. In the context of the present invention, the engagement velocity, vₑ, of the shuttle with the linear is held constant. Nevertheless, the force of gravity continues acting to accelerate the shuttle. The linear generator, however, restrains acceleration of an engaged shuttle, and the work to do this is harvested from the linear generator as the machine's output. Mathematically, for the work-energy relationship:

$$\begin{matrix}U = {\int }_{s} Fds = {\int }_{s} ( {m}_{s} a ) ds = {\int }_{s} ( {m}_{s} ) ( dv \vert dt ) ds = {\int }_{s} ( {m}_{s} ) ( ds / dt ) dv = {\int }_{s} {m}_{s} vdv = 1 / 2 {m}_{s} {v}^{2} \\ U = {\int }_{s} Fds = 1 / 2 {m}_{s} {v}_{e}^{2}\end{matrix}$$

For the design of a machine, values for physical components and operational factors of the machine must be selected to achieve an optimal performance efficiency. The selection of these values, and their resultant operational consequences are crucial considerations in the design of a machine.

### DESCRIPTION OF PREFERRED EMBODIMENTS

### Pre-Selected Variables

Pₒ: machine output power, Uₒ/sec, expressed in ft-lbs/sec.
B: shuttle buoyancy factor.
Lₑ: length of the linear generator.
vₑ: constant velocity for shuttle engagement with the linear generator.

### Calculated Variables

Uₒ/sec=output work value based on KE, where Uₒ=½mv²=½(Wₛ/g)vₑ² [use to solve for Wₛ].
Wₛ: shuttle weight, Wₛ=2gUₒ/vₑ².
L_{f}: shuttle acceleration free fall distance to attain vₑ, L_{f}=vₑ²/2g.
H: head height of water tower, H=Lₑ+L_{f}.
h: distance of shuttle travel on linear generator per second.
W_{w}: water weight (shuttle volume equivalent), W_{w}=Wₛ/B.
sk: recoil spring input work, where “s” is compression distance and “k” is a spring constant.
Uᵢ: input work value based on PE, where Uᵢ=W_{w}H/Z; and also Uᵢ=sk.
Uₒ: Output work value based on Pₒ.
X: engagement time between shuttle and linear generator; X=Lₑ/vₑ.
Y:=time duration for shuttle transit from linear generator separation to water tower entry (TBD).
Z:=reset time component (TBD) [Time in seconds for shuttle to rise in the water tower].

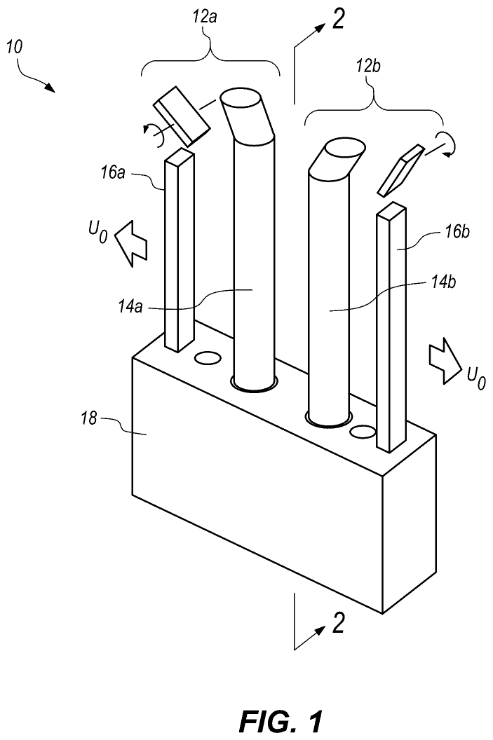

Referring initially to FIG. 1 a machine for generating electricity is shown and is generally designated 10. As shown, the machine 10 includes a pair of tandem electricity generating units 12a and 12b. Each electricity generating unit 12a,b is shown to include a respective water tower 14a or 14b which is vertically aligned with a respective linear generator 16a or 16b. Further, the electricity generating units 12a and 12b are mounted on a transfer tank 18. In combination with each other, the electricity generating units 12a and 12b define a hydro-electric component for the machine 10.

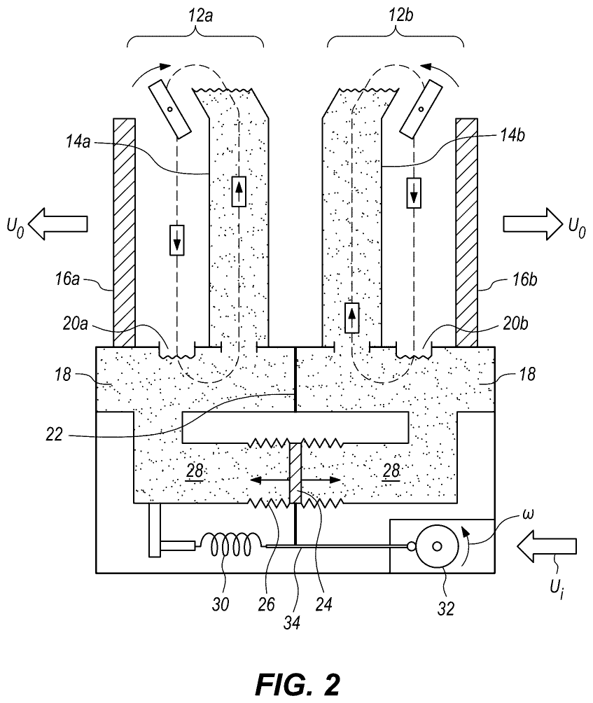

FIG. 2 shows that the electricity generating unit 12a includes an access port 20a which provides access into the transfer tank 18. Similarly, the electricity generating unit 12b includes an access port 20b which also provides access into the transfer tank 18. In the transfer tank 18, however, a barrier 22 hydraulically separates the electricity generating unit 12a from the electricity generating unit 12b. Consequently, the electricity generating units 12a and 12b operate separately to provide separate units of output work Uo. On the other hand, this cooperation of structure allows the electricity generating units 12a and 12b to be driven by a same hydro-mechanical component.

Still referring to FIG. 2 it is shown that the hydro-mechanical component of the machine 10 includes a piston 24 which is engaged with a bellows 26. Specifically, the bellows 26 allows reciprocal movements of the piston 24 back and forth in a water conduit 28 of the transfer tank 18. Consequently, these movements will individually manipulate water levels in both of the water towers 14a and 14b. Also, like the barrier 22, the piston 24 hydraulically separates the electricity generating unit 12a from the electricity generating unit 12b.

In addition to the piston 24, the hydro-mechanical component of the machine 10 includes a recoil spring 30 and a drive cam 32. As shown in FIG. 2, a drive bar 34 interconnects the drive cam 32 with the piston 24, and with the recoil spring 30. Thus, a rotation of the drive cam 32 at an angular velocity ω will exercise both the piston 24 and the recoil spring 30.

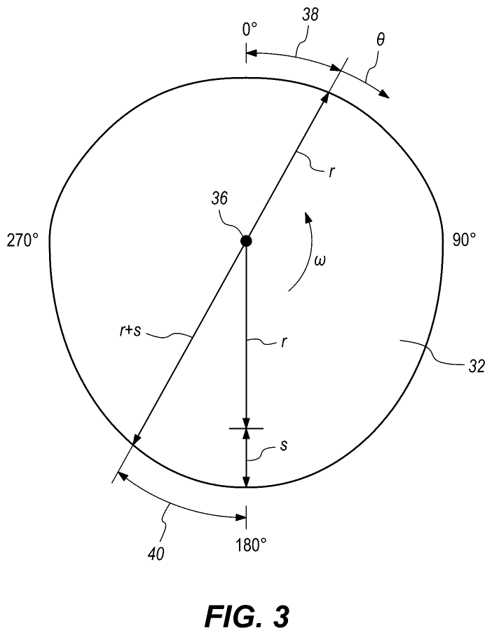

In detail, FIG. 3 shows the structural configuration of the drive cam 32 is essentially defined by changes in the distance of its periphery from an eccentric axis of rotation 36 at a rotation angle θ. With reference to FIG. 3, it is to be appreciated that the direction of rotation for ω is arbitrary. For purposes of this disclosure, ω is shown to be in a counter-clockwise direction with the distance between the eccentric axis of ration 36 and the periphery of drive cam 32 increasingly from “r” to “r+s” as θ increases from 0° to 180°. Note: this increase need not be uniform, and most likely will not be.

An important consideration when cross referencing FIG. 3 with FIG. 2 is that as the angle θ increases between θ=0° and 180°, the piston 24 moves to the left through the distance “s”. On the other hand, as the angle θ decreases between θ=180° and 360°, the piston 24 moves back to the right and the distance between the eccentric axis of rotation 36 and the periphery of drive cam 32 decreases back to the distance “r”. As further indicated in FIG. 3, a reset capability can be engineered for the machine 10 by maintaining “r” constant during a predetermined rotation arc 38, while simultaneously maintaining “r+s” constant during the diametrically opposed rotation arc 40.

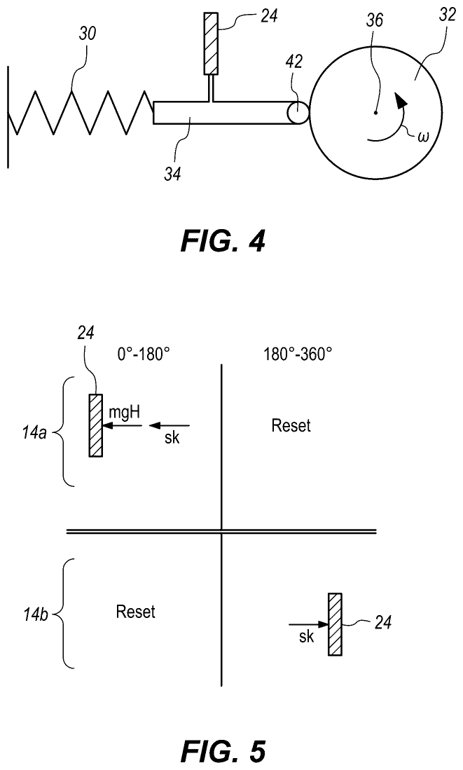

With reference to FIG. 4 the hydro-mechanical component of the machine 10 is shown separate from the hydro-electric component. Functionally, as the drive cam 32 rotates it pushes against a roller 42 mounted on the drive bar 34 to facilitate reciprocation of the drive bar 34. This moves the piston 24 to the left. It will also compress the recoil spring 30. Thus, this action requires two units of input work 2Uᵢ.

In detail, one of the input work units exerted on drive bar 34 during a machine cycle is referred to here as U_{i(mgH)} to indicate its purpose is raise water in one of the respective water towers 14a and 14b of the machine 10. Specifically, in the expression for the work unit U_{i(mgH)}=m_{w}gH, m_{w} is the water mass being raised, “g” is gravity, and H is the head height of the water tower 14a or 14b where water is being raised. The other input work unit is designated Uₛₖ to identify the work that is stored in the recoil spring 30 as water is being raised in one tower 14, and then subsequently released during the machine work cycle to raise the water mass in the other water tower 14. Specifically, the value of Uₛₖ=sk, where “k” is the spring constant and “s” is the spring compression distance. Note: U_{(mgH)}=Uₛₖ where “s” equals both the compression distance of recoil spring 30 and the travel distance of the piston 24 during a machine work cycle.

FIG. 5 correlates the forces acting on the piston 24, for each water tower 14a and 14b, during a rotation of the drive cam 32 through rotation arcs θ=0°-180° and θ=180°-360°. Note: Uₛₖ is stored during the rotation arc θ=0°-180°, and subsequently used during the rotation arc θ=180°-360°. Specifically, FIG. 5 shows that during an operation of the machine 10 the tower 14b is reset during rotation arc θ=0°-180°, and tower 14b is reset during rotation arc θ=180°-360°.

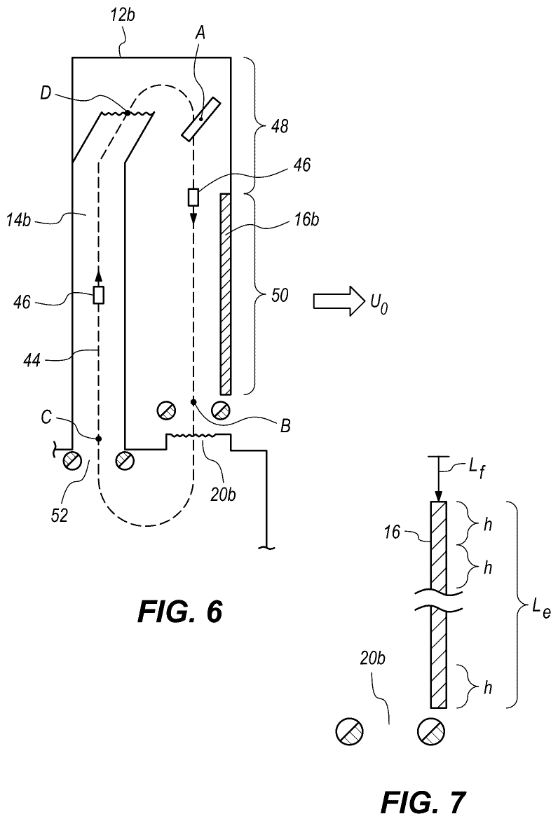

In FIG. 6, a schematic is shown of the pathway 44 that is followed by a shuttle 46 during an operation of the machine 10 in the electricity generating unit 12b. Specifically, the pathway 44 is shown as a succession of sequentially connected time sectors. For example, an A-B sector of the shuttle pathway 44 extends from an elevated start point A where the shuttle 46 begins its free fall distance 48 into engagement with the linear generator 16b. The A-B section then continues through an engagement distance 50 to a point B where the shuttle 46 disengages from the linear generator 16b. Sequentially, a B-C sector of the shuttle pathway 44 is shown to include valving components of the machine 10 associated with the access port 20b at the point B and with a transfer port 52 at the point C. Specifically, the B-C sector must require sufficient time to allow for the transit of the shuttle 44 from its disengagement with the linear generator 16b to its entry into the water tower 14b. Further, a C-D time sector identifies the portion of the pathway 44 where the shuttle 46 rises by it buoyancy to the top of water tower 14b where in breaches. The importance of the C-D time sector is that it has the potential to accommodate at least one additional shuttle 46 in the machine 10 during a machine work cycle. Finally, a D-A sector of the shuttle pathway 44 extends from where shuttle 46 breaches from the water tower 14b to the elevated start point A for a subsequent machine cycle.

As a practical matter it is necessary for time sector B-C to have a longer duration than the time required for sector A-B. In part this requirement is based on the simple fact that both the access port 22b and the transfer port 52 cannot be open at the same time. Stated differently, one shuttle 46 must exit the transfer tank 18 before another shuttle 46 can enter the transfer tank 18.

The output work Uₒ generated by the linear generator 16b during the time section A-B will be best appreciated by cross referencing FIG. 6 with FIG. 7. Specifically, for this evaluation, the length Lₑ of the linear generator 16b (FIG. 7) will depend on both a desired output power Pₒ for the machine 10 and the engagement velocity, vₑ. of the shuttle 46 with the linear generator 16b. Moreover, because Uᵢ is greater than Uₒ, based on the ratio (Uᵢ/sec)/(Uₒ/sec)=Uᵢ/sec/Pₒ=m_{w}gH/msLₑ=1.55 [approximately], each electricity generating unit 12 of the machine 10 must operate for more than 1.55 seconds during every machine work cycle.

With specific reference to FIG. 7, the cumulative effect of a total output work Uₒ₍ₜₒₜₐₗ₎ for an electricity generating unit 12 of the machine 10, is based on the fact that Uₒ/sec=Pₒ is preselected. Accordingly, as shown in FIG. 7, Uₒ/sec=mₛh/sec, where mₛ is the shuttle mass, and “h” is the distance traveled by the shuttle 46 along the linear generator 16b every second. Thus, in a configuration for the machine 10 wherein the shuttle 46 is engaged with the linear generator 16b for X seconds duration, the Uₒ₍ₜₒₜₐₗ₎=XUₒ for the electricity generating unit 12b, and Uₒ₍ₜₒₜₐₗ₎=2XUₒ for the machine 10.

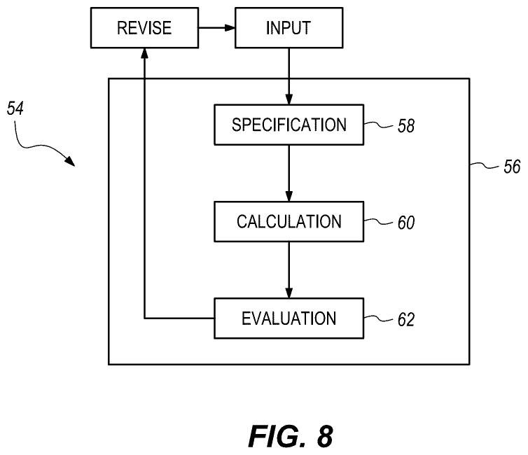

An operational methodology 54 is provided in FIG. 8 which essentially outlines a procedure 56 for designing a machine 10 in accordance with the present invention. As shown in FIG. 8 the procedure 56 involves the activities of i) specifying preselected design factors needed to construct the machine 10; ii) calculating values for the design factors values to establish structural characteristics and operational attributes of components for the machine; and iii) evaluating an interaction of the machine's operational components for optimizing values of the selected design factors to achieve a desired machine performance.

In detail, the methodology 54 will include a specification function 58 wherein values for design factors for the machine 10 are established. The specification function 58 can begin simply with the selection of a desired output power Pₒ for each electricity generating unit 12. Also, a constant velocity vₑ for shuttle/generator engagement, and a length Lₑ for the linear generator can be reasonably chosen.

Also included in the methodology 54 is a calculation function 60 which will include the step of mathematically determining a shuttle weight Ws. Then, using the relationship Uₒ=LₑWₛ, a value for Ws can be determined. Another step in the calculation function 60 involves establishing a shuttle free-fall distance L_{f} needed for the shuttle to accelerate to its constant engagement velocity vₑ, where L_{f}=vₑ²/2g.

As noted above, when starting with a desired shuttle weight Wₛ, rather than having a value for the output power, Pₒ must still be calculated. Note: vₑ and a length Lₑ can still be reasonable chosen. The calculation of an output power Pₒ=Uₒ/sec can then be made using Wₛ/g=mₛ in the work-energy relationship Uₒ=½mₛvₑ². The calculation for Wₛ here is then based on the steady state kinetic energy KE of the shuttle 46 at the velocity vₑ. The shuttle weight Wₛ can be determined by equation Wₛ=2gUₒ/vₑ². Another design factor that can be determined in the calculation function 60 is the buoyancy factor B for the shuttle 45, where B is the ratio of the shuttle weight Wₛ to the weight W_{w} of an equivalent water volume which is displaced when the shuttle 46 is submerged in the transfer tank 18. The weight W_{w} for a water volume equal to the shuttle volume can then be calculated where W_{w}=Wₛ/B.

Additional steps in the calculation function 60 include calculating an input work requirement Uᵢ for operating each electricity generator of the machine, where Uᵢ=W_{w}H, and calculating an output work Uₒ generated by a single water tower, where Uₒ is based on the kinetic energy of the shuttle, and the output power Pₒ is expressed as Uₒ/sec=½(Wₛ/g)vₑ²/sec.

The evaluation function 62 for the procedure 56 involves comparing the total input work Uᵢ and the total output work Uₒ machine performance of the two electricity generating units 12a and 12b. More specifically, this involves comparing Uₒ₍ₜₒₜₐₗ₎ with Uᵢ₍ₜₒₜₐₗ₎, where Uₒ₍ₜₒₜₐₗ₎ equals 2X(Uₒ/sec), and Uᵢ₍ₜₒₜₐₗ₎ equals 2Z(U_{i(sec)}/Z)=2Uᵢ. sustaining the operation of the machine by taking feedback from the machine output for a net output U₍ₙₑₜ₎=2X(Uₒ/sec)−2Uᵢ.

### Work Evaluations

Uᵢ₍ₜₒₜₐₗ₎=Uᵢ+sk=2Uᵢ with a finite value, regardless of X. This evaluation is reached because the machine 10 has tandem water towers 14a and 14b. Accordingly, Uᵢ=m_{w}gH powers one tower of the machine during the first half of the machine's work cycle, and Uᵢ=sk powers the other water tower of the machine 10 during the second half of the work cycle. Thus, Uᵢ₍ₜₒₜₐₗ₎=2Uᵢ for the machine 10 during each machine work cycle.

As disclosed above, Uₒ₍ₜₒₜₐₗ₎=2XUₒ with a cumulative value during the machine work cycle.

$$A Numerical Example$$

$$\begin{matrix}Let : B = 0.7 ; {L}_{e} = 20 ft ; {v}_{e} = 10 ft / sec ; {W}_{s} = 200 lbs . ; and X = {L}_{e} / {v}_{e} = 2. \\ Calculated {L}_{f} = {v}_{e}^{2} / 2 g = {( 10 )}^{2} / 64.4 = 1.55 ft . \\ Calculated : {U}_{o} = {W}_{s} ( {L}_{e} ) = 4000 ft - lbs . \\ Calculated : H = {L}_{e} + {L}_{f} = 20 + 1.5 5. \\ Calculated : {W}_{w} = {W}_{s} / B = 200 / 0.7 = 285 \text{.7} . \\ Calculated : {U}_{i} = {W}_{w} H = ( 200 / 0.7 ) ( 20 + 1.55 ) = 6157 ft - lbs . \\ {U}_{i ( total )} = {U}_{i} + sk = 2 ( 6157 ) = 12 , 314 ft - lbs . \\ {U}_{o ( total )} = 2 {XU}_{o} sec = 2 ( 2 ) ( 4000 ) = 16 , 000 ft - lbs . \\ {U}_{net} = 2 {XU}_{o} - 2 {U}_{i} . \\ {U}_{i} / {U}_{o} = 6 \; 157 / 4000 = 1.55 .\end{matrix}$$

In this example, Uₙₑₜ=2XUₒ−2Uᵢ=(2)(2)(4000)−(2)(6,157)=1600−12,314=3,686 ft-lbs.

While the system and method for generating electricity with tandem towers as herein shown and disclosed in detail is fully capable of obtaining the object and providing the advantages herein before state, it is to be understood that it is merely illustrative of the presently preferred embodiments of the invention and that no limitations are intended to the details of construction or design herein shown other than as described in the appended claims.

1. A method for designing a machine to generate electricity using motive forces from the earth's gravitational field, wherein the machine includes tandem electricity generating units, wherein the electricity generating unit has a water tower mounted vertically above a transfer tank for fluid communication therewith, and wherein the water tower is juxtaposed with a vertically aligned linear generator above the transfer tank to create the electricity generating unit, and further the machine has a mechanism positioned in the transfer tank for manipulating water levels in the water tower to return a buoyant shuttle to an elevated start point where it is dropped into engagement with the linear generator to operate the electricity generating unit, wherein the method comprises the steps of:
specifying values for a plurality of individual design factors needed to construct the machine;
calculating values for the design factors values to establish structural characteristics and operational attributes of components for the machine;
evaluating an interaction of the machine's operational components for optimizing values of the selected design factors to achieve a desired machine performance; and
preparing a protocol for designing a machine, wherein the protocol incorporates the optimized design factors.

2. The method of claim 1 wherein the design factors for an electricity generating unit are selected from the group consisting of:
an output power Pₒ for each electricity generating unit of the machine;
a constant velocity vₑ for the engagement of each shuttle with its respective linear generator;
a length Lₑ for the linear generator; and
a buoyancy factor B for the shuttle, where B is the ratio of the shuttle weight to the weight of an equivalent water volume displaced when the shuttle is submerged.

3. The method of claim 2 further comprising the steps of:
mathematically determining a shuttle weight Wₛ based on the equivalence of a selected output power Pₒ, and the steady state kinetic energy KE of the shuttle at the velocity vₑ during shuttle engagement with the linear generator;
selecting a head height H for the water tower;
establishing a shuttle free-fall distance L_{f} needed for the shuttle to accelerate to its constant engagement velocity vₑ;
calculating a weight W_{w} for a water volume equal to the shuttle volume where W_{w}=Wₛ/B;
calculating an input work requirement Uᵢ for operating each electricity generator of the machine, where Uᵢ=W_{w}H; and
calculating an output work Uₒ generated by a single water tower, where Uₒ is based on kinetic energy of the shuttle and the output power Pₒ expressed as Uₒ/sec=½(Wₛ/g)vₑ²/sec.

4. The method of claim 3 wherein H is greater than L_{f}+Lₑ.

5. The method of claim 4 wherein each electricity generating unit has a work cycle which comprises;
a work output-time component of X seconds duration where the shuttle is engaged with the linear generator;
a transit-time component of Y seconds duration which begins when the shuttle disengages from the linear generator to transit through the transfer tank, and ends when the shuttle enters the water tower from the transfer tank; and
a shuttle reset-time component of Z seconds duration where the shuttle rises in the water tower to a start point for the next machine work cycle.

6. The method of claim 5 wherein machine performance for two electricity generating units is measured by comparing Uₒ₍ₜₒₜₐₗ₎ with Uᵢ₍ₜₒₜₐₗ₎, where Uₒ₍ₜₒₜₐₗ₎ equals 2X(Uₒ/sec), and Uᵢ₍ₜₒₜₐₗ₎ equals 2Z(U_{i(sec)}/Z)=2Uᵢ.

7. The method of claim 6 wherein Y is greater than X, and Z is greater than Y.

8. The method of claim 3 wherein the machine comprises a first electricity generating unit and a second electricity generating unit with a water channel having a first end connected in fluid communication with the water tower of the first electricity generating unit and a second end connected in fluid communication with the water tower of the second electricity generating unit and a piston positioned for reciprocal movements in the water channel to operate the first electricity generating unit during the first-half of a machine cycle, and to operate the second electricity generating unit during a second-half of the machine cycle, wherein the method further comprises the steps of:
applying a force against the piston at the beginning of the machine cycle to move the piston to the left through a distance “s” to do an amount of input work equal to 2Uᵢ during the first-half machine cycle, wherein a first U_{i(mgH)}=W_{w}H is used to operate the first electricity generating unit and a second Uᵢ₍ₛₖ₎ is stored by simultaneously compressing a recoil spring connected to the piston, wherein “k” is a spring constant and the second Uᵢ₍ₛₖ₎=sk; and
allowing the piston to move to the right during the second-half work cycle to decompress the spring and use the stored Uᵢ₍ₛₖ₎ to operate the second electricity generating unit.

9. The method of claim 8 further comprising the steps of:
establishing a time duration for the machine cycle equal to X seconds; and
sustaining the operation of the machine by taking feedback from the machine output for a net output U₍ₙₑₜ₎=2X(Uₒ/sec)−2Uᵢ.

10. A machine for generating electricity using motive forces from the earth's gravitational field, wherein the machine sequentially drives two electricity generating units, and wherein each electricity driving unit comprises:
a transfer tank;
a water tower mounted vertically above and on the transfer tank for fluid communication therewith;
a linear generator mounted on the transfer tank, wherein the linear generator is juxtaposed in vertical alignment with the water tower;
a buoyant shuttle; and
a conduit connecting the electricity generating unit with a pumping mechanism to reciprocally manipulate water levels in the water tower to return a buoyant shuttle to an elevated start point after the shuttle has been dropped for engagement with the linear generator at a constant engagement velocity under the influence of gravity to operate the electricity generating unit.

11. A machine as recited in claim 10 wherein the pumping mechanism comprises:
a cam drive;
a means for rotating the cam drive about an eccentric axis of rotation at a predetermined angular velocity ω, wherein each 360° rotation of the cam drive defines a machine work/energy cycle;
a drive rod engaged with the cam drive, wherein the drive rod is moved in response to a rotation of the cam drive in a back and forth movement through a predetermined distance “s” in X seconds each way, during a 2X seconds work/energy machine cycle; and
a piston plate having a first side and a second side, wherein the piston plate is attached to the drive rod for reciprocating movement to alternatingly operate a first electricity generating unit in X seconds, and a second electricity generating unit in X seconds, during a 2X seconds machine cycle.

12. A machine as recited in claim 11 wherein the first electricity generating unit is mounted on the transfer tank and the second electricity generating unit is juxtaposed and vertically aligned with the first electricity generating unit, and wherein the water tower of each electricity generating unit is individually connected in fluid communication with a respective side of the piston plate, and further wherein the machine further comprises:
a recoil spring engaged with the drive rod, wherein the recoil spring has a spring constant “k” and is compressed by the drive rod to store work/energy, Uᵢ₍ₛₖ₎=sk, while simultaneously the piston plate is being moved during the first-half work cycle to expend an active work/energy U_{i(mgH)} to operate the first electricity generating unit, and further wherein subsequently, Uᵢ₍ₛₖ₎ in the recoil spring is expended during a second-half work cycle to operate the second electricity generating unit.

13. A machine as recited in claim 12 wherein U_{i(mgH)} and Uᵢ₍ₛₖ₎ are equal and Uᵢ₍ₜₒₜₐₗ₎=U_{i(mgH)}+Uᵢ₍ₛₖ₎=2U.

14. A machine as recited in claim 13 wherein Uₒ equals the per second value of the kinetic energy of a shuttle, Uₒ/sec=½(Wₛ/g)vₑ²/sec where Wₛ is the shuttle weight and vₑ is the engagement velocity of the shuttle with the linear generator.

15. A machine as recited in claim 14 wherein an input work Uᵢ is required to operate each electricity generator and equals the weight of water W_{w} to be lifted during half the 2X second machine cycle times the head height H of water in the respective water tower, where Uᵢ=U₍ₛₖ₎=U_{i(mgH)}.

16. A machine as recited in claim 15 further comprising a feedback loop which removes a work value equal to 2Uᵢ from Uₒ₍ₜₒₜₐₗ₎ for use in operating the machine, to provide a net output work of value U₍ₙₑₜ₎=2XUₒ−2Uᵢ wherein X>Uᵢ/Uₒ.

17. A protocol for designing a machine to generate electricity using motive forces from the earth's gravitational field, where the machine operates by dropping a buoyant shuttle from an elevated start point under the influence of gravity into engagement with a linear generator for converting the kinetic energy of the falling shuttle into electricity, and for returning the shuttle to the start point via a water tower under the influence of the buoyancy force on the shuttle, wherein the protocol comprises the steps of:
picking an output power Pₒ for the machine;
selecting design factor values, based on Pₒ, for mass and velocity elements of the kinetic energy expression in the work-energy relationship needed to construct the machine;
calculating structural characteristics and operational attributes for the machine using design factor values;
evaluating calculations of the design factors to determine machine performance; and
revising selected design factor values to optimize machine performance.

18. The protocol of claim 17 wherein the selected design factor values comprise:
B, a shuttle buoyancy factor;
Lₑ, a length for the linear generator;
vₑ, a steady state engagement velocity of the shuttle with the linear generator; and
Uₒ, an output work value where Uₒ/sec=Pₒ.

19. The protocol of claim 18 wherein calculations for physical characteristics and operational attributes of the machine involve determining values for machine variables which comprise:
Wₛ a shuttle weight wherein Wₛ=2gUₒ/vₑ²;
W_{w}=a water volume weight where W_{w}=Wₛ/B;
X=time duration shuttle is engagement with the linear generator, where X=Lₑ/vₑ;
Y=time duration from shuttle/linear generator separation to water tower entry;
L_{f}=a free-fall distance for shuttle to attain vₑ, where L_{f}=vₑ²/2g;
H=a water tower head height, where H=Lₑ+L_{f};
Uₒ=WₛLₑ;
Uᵢ=W_{w}H;
U₍ₙₑₜ₎ is the net output work (twin towers) where, Uₙₑₜ₎=Uₒ₍ₜₒₜₐₗ₎−Uᵢ₍ₜₒₜₐₗ₎=2XUₒ−2Uᵢ; and
sk=Uᵢ.

20. The protocol of claim 19 wherein calculation results from claim 19 are evaluated within constraints which comprise:
X is greater than Uₒ/Uᵢ; and
Y is greater than X.
